(19) United States
(12) Patent Application Publication
(10) Pub. No.: US 2003/0156126 A1
(43) Pub. Date: Aug. 21, 2003

(54) Image display apparatus and method

(75) Inventor: Isao Tsuji, Yokkaichi-city (JP)

Correspondence Address: GREENBLUM & BERNSTEIN, P.L.C., 1950 ROLAND CLARKE PLACE, RESTON, VA, 20191, US

(73) Assignee: Sumitomo Wiring Systems, Ltd., Yokkaichi-city (JP)

(21) Appl. No.: 10/359,065

(22) Filed: Feb. 6, 2003

(30) Foreign Application Priority Data
Feb. 18, 2002 (JP) 2002-040065

(51) Int. Cl. G09G 5/00

(52) U.S. Cl. 345/660

(57) ABSTRACT

Image display apparatus in which an actual size of a target object can be determined by a user. The display apparatus includes a target image of a target object configured to be displayed on a computer screen, and a reference image of a reference object configured to be displayed on the computer screen together with the target image, a size of the reference object known to the user. The user may visually identify the actual size of the target object on the computer screen by comparing the target image with the reference image.

### BACKGROUND OF THE INVENTION

The present invention relates to an easy visual identification apparatus and method for a target image, and more particularly, relates to an image display apparatus wherein an enlargement rate or a reduction rate of the target image, which is displayed on a computer screen, can be visually identified in CAD (computer aided design), CAM (computer aided manufacturing), CAE (computer aided engineering), VR (virtual reality), simulation, or the

### DESCRIPTION OF THE RELATED ART

In the related art, an apparatus such as a CAD apparatus or the like displays a target image of a target object on a computer screen and provides for the enlarging and/or reducing this target image on the screen. A user proceeds with a design work while enlarging or reducing a target image of a design target object displayed on the computer screen by using a pointing device such as a mouse or the like, or a keyboard. In the related art apparatus, an enlargement rate or a reduction rate of the target image is displayed by a “%” (percent) indication or scale of ruler or unit (mm, cm, feet, etc.) on the computer screen in order to inform the user by how much the present target image is enlarged or reduced on the computer screen.

However, since it is difficult for the user to instinctively gauge the enlargement rate or the reduction rate of the enlarged or reduced target image from the above “%” indication, the user may be confused as to the size of the actual design target object.

For example, where the target image is enlarged on the computer screen in a design, although a very small clearance is defined in a real target object, the user mistakenly perceive that the clearance is very large from the impression conveyed by the target image displayed on the screen.

If the user proceeds with the design work with the above illusion in mind, the user may “overdesign” the image dimensions to obtain unnecessary accuracy that is not required for in a given design, thereby wasting time and effort in creating the design. Thus, the time required for creating the design is unnecessarily lengthened.

In situations where the target image is displayed on the screen in a three-dimension form, the “%” indication for the enlargement rate or reduction rate may also confuse the user.

### SUMMARY OF THE INVENTION

In view of the above problem, the present invention is to provides a way for a user to instinctively understand a size of a target image displayed on a computer screen.

The present invention provides an image display apparatus in which an actual, real size of a target object can be understood from a target image on a computer screen. A reference image of a reference object, the size of which is already understood by the user, is displayed on the computer screen along with the target image of the target object. A real size of the target object can be visually recognized and/or identified on the computer screen by comparing and contrasting the target image with the reference image.

According to the above construction, since the user can contrast at a glance the size of the target image with the reference image on the same screen, the user can instinctively and visually understand to what extent the actual size of the target image of the target object is indicated on the screen.

For example, when an image of a product is presented on a TV monitor or by a projector, even the viewing audience does not know a real size of the product, and cannot easily determine the actual size of the target image at a glance.

The target image of the target object can be enlarged and/or reduced on the computer screen. The reference image of the reference object can be enlarged or reduced on the computer screen in accordance with an enlargement rate or a reduction rate of the target image.

According to the present invention, the user can instinctively understand to what extent the target image is enlarged or reduced by comparing and/or contrasting the target image with a reference image of a reference object, even if the target image is enlarged or reduced.

The reference image of the reference object may be displayed in a blank area or overlaid transparent image on the computer screen on which the target image of the target object is displayed. Alternatively, the reference image of the reference object may overlap or be overlapped by the target image of the target object, with the reference image and/or the target image presented as a translucent image.

If the reference image is presented in the blank area on the screen, the reference image is directly displayed. If the reference image of the reference object overlaps the target image of the target object, it is possible for the user to easily view the reference image without any problem, by translucently showing the reference image.

The known reference object is an object for which the actual size is easily and instinctively understood and known by the user, such as a pack of cigarettes, a coin of a predetermined denomination, a business card, a postcard, a postage stamp, a floppy disk, a CD, a computer keyboard, a human hand, a cassette tape, and the like.

Thus, if the displayed reference image is a pack of cigarettes or other conventionally well-known image, the user can instinctively gauge the extent of enlargement and/or reduction of the target image on the screen, since the user is familiar with the actual size of the reference object.

For example, if the present invention is to be used in a sporting goods factory, then the present invention may be selected to provide a soccer ball or the like as the specific kind of reference object.

The image display apparatus may be a CAD (computer aided design) apparatus, wherein the target image of the target object is represented as a three-dimensional design target image. A rotation indicator that indicates a direction in association with an indicating direction of the design target image is displayed on a screen of the image display apparatus. The rotation indicator is rotated in connection with rotation of the design target image on the screen.

When using the above image display apparatus in a CAD apparatus, since the user can easily understand the enlargement rate and/or reduction rate of the target image displayed on the screen, it is possible to prevent the user from mistaking the actual size represented by the target image.

Accordingly, the present invention helps to prevent overdesign of objects, thereby enhancing design efficiency and shortening lead-time of design.

Also, when rotating the three-dimensionally displayed target image, by using an input device such as a mouse or the like, the user can readily understand and determine the inclination amount of the rotating angle of the target image.

In the image display apparatus of the present invention, the actual size of a target object can be determined by a user. The display apparatus includes a target image of a target object configured to be displayed on a computer screen, and a reference image of a reference object configured to be displayed on the computer screen together with the target image, a size of the reference object known to the user. The user may visually recognize the actual size of the target object on the computer screen by comparing the target image with the reference image.

In one feature of the image display apparatus, the target image of the target object is configured to be at least one of enlarged and reduced on the computer screen, and the reference image of the reference object is configured to correspondingly be at least one of enlarged and reduced on the computer screen in accordance with a respective at least one of an enlargement rate and a reduction rate of the target image.

In another feature of the invention, the reference image of the reference object may at least one of be displayed on a blank area of the computer screen, and translucently overlap the target image.

In a further feature of the invention the reference object may be one of a pack of cigarettes, a coin of a predetermined denomination, a business card, a postcard, a postage stamp, a floppy disk, a CD, a computer keyboard, a human hand, a telephone booth, a telephone keypad, and a cassette tape.

Another feature of the invention a provides rotation indicator configured be displayed on the screen and further configured to indicate a direction in association with an orientation of the target image, the rotation indicator configured to rotate in association with rotation of the target image, wherein the image display apparatus is a CAD (computer aided design) apparatus; and the target image has a three-dimensional appearance on the screen.

Yet another feature of the invention provides an additional reference image configured to replace the reference image when the target image is one of enlarged and reduced, an actual size of the additional reference image being smaller than the reference image when the target image is enlarged on the screen, and the actual size of the additional reference image being larger than the reference image when the target image is reduced on the screen.

In still another feature of the invention the entirety of at least one of the reference image and the additional reference image may be configured to fit the screen.

The image display method of the present invention includes displaying a target image of a target object on a computer screen, displaying, together with the target image, a reference image of a reference object on the computer screen, a size of the reference object known to a user, comparing the target image with the reference image, and visually recognizing, by the user, the actual size of the target object on the computer screen, based on the comparing.

A feature of the method of the present invention may further include at least one of enlarging and reducing the target image on the computer screen, and correspondingly enlarging the reference image on the computer screen when the target image is enlarged, and correspondingly reducing the reference image on the computer screen when the target image is reduced.

Another feature of the invention may still further include displaying the reference image on a blank area of the computer screen, and translucently overlapping the reference image over the target image.

The method may yet also include displaying a rotation indicator on the screen indicating, with the rotation indicator, a direction in association with an orientation of the target image, and rotating the rotation indicator in association with rotation of the target image, wherein the target image has a three-dimensional appearance on the screen.

Another aspect of the method may include replacing the reference image with an additional reference image when the target image is one of enlarged and reduced, an actual size of the additional reference image being smaller than the reference image when the target image is enlarged on the screen, and the actual size of the additional reference image being larger than the reference image when the target image is reduced on the screen.

Other exemplary embodiments and advantages of the present invention may be ascertained by reviewing the present disclosure and the accompanying drawings.

### BRIEF DESCRIPTION OF THE DRAWINGS

The present invention is further described in the detailed description which follows, in reference to the noted plurality of drawings by way of non-limiting examples of certain embodiments of the present invention, in which like numerals represent like elements throughout the several views of the drawings, and wherein:

FIG. 1 is a front elevation view of a first embodiment of an image display apparatus in accordance with the present invention;

FIG. 2 is a front elevation view of a computer screen, illustrating an enlarged image on the screen;

FIG. 3 is a flowchart of a enlarging and reducing system in the first embodiment;

FIG. 4A is a front elevation view of a second embodiment of the image display apparatus before enlargement of a target image;

FIG. 4B is a front elevation view of the second embodiment of the image display apparatus after enlargement of the target image;

FIG. 5 is a flowchart of an enlarging and reducing system in the second embodiment;

FIG. 6A is a front elevation view of a third embodiment of the image display apparatus before rotation of a target image;

FIG. 6B is a front elevation view of the third embodiment of the image display apparatus after rotation of a target image; and

FIG. 7 is a flowchart of a rotating system and enlarging and reducing system in the third embodiment.

### DETAILED DESCRIPTION OF THE PREFERRED EMBODIMENTS

The particulars shown herein are by way of example and for purposes of illustrative discussion of the embodiments of the present invention only and are presented in the cause of providing what is believed to be the most useful and readily understood description of the principles and conceptual aspects of the present invention. In this regard, no attempt is made to show structural details of the present invention in more detail than is necessary for the fundamental understanding of the present invention, the description taken with the drawings making apparent to those skilled in the art how the several forms of the present invention may be embodied in practice.

Referring to the drawings wherein like characters represent like elements, embodiments of an image display apparatus in accordance with the present invention will be described below.

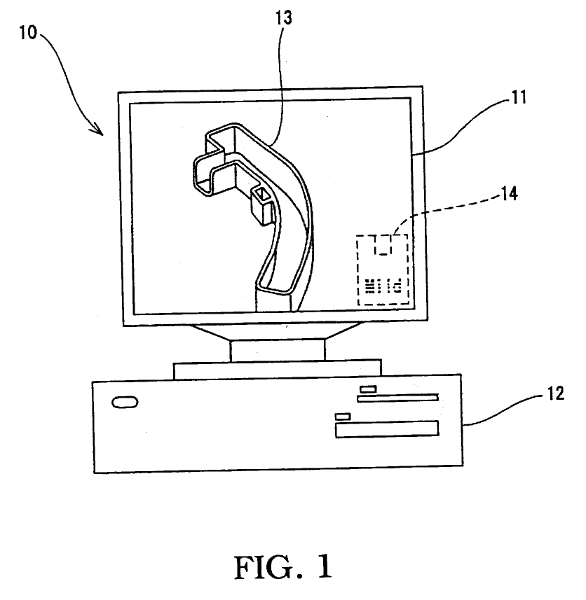

FIGS. 1 to 3 show a first embodiment of the image display apparatus in accordance with the present invention.

The image display apparatus in the first embodiment includes a CAD (computer aided design) apparatus 10. The CAD apparatus 10 includes a display (computer screen) 11; a body 12 having a CPU (central processing unit), a memory, a hard disk, an external recording medium reading-out device, and the like; and an input device (not shown) including a mouse, a keyboard, and the like.

FIG. 1 shows an example of a screen 11 display during a design process. A target image 13 of a design target object is displayed on the screen 11 and a reference image 14 of a reference object such as a pack of cigarettes in the first embodiment is displayed on the screen 11 simultaneously in a translucent form, shown as phantom lines.

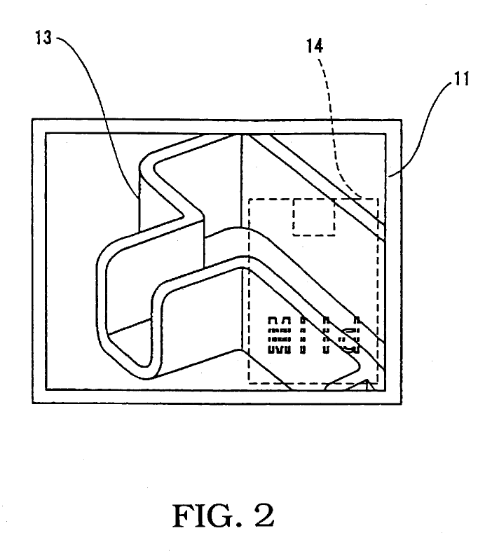

The size of the reference image 14 is displayed on the screen 11 in proportion to and at the same enlargement or reduction rate as that of the target image 13 in the screen 11. In other words the target image 13 and reference image 14 have the same proportions on the screen 11. For example, if the target image 13 is enlarged on the screen 11, the reference image is correspondingly and proportionally enlarged in connection with the enlargement of the target image 13, as shown in FIG. 2.

At this time, although the enlarged reference image 14 overlap on the target image 13, the design may still effectively be worked on, since the reference image is translucent.

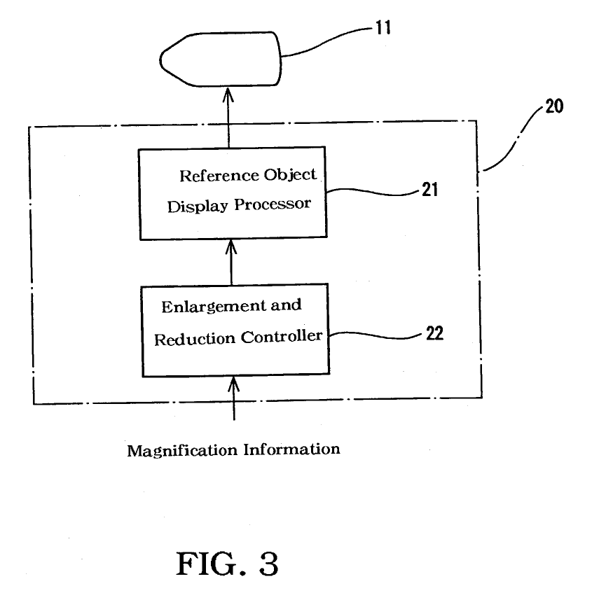

A system 20 for enlarging and reducing the reference image 14 is stored in a hard disk or other computer-readable medium of the body 12, as a computer program. The enlarging and reducing system 20 is processed by being read out from a memory. In more detail, as shown in a flowchart in FIG. 3, magnification information (i.e., enlargement and reduction information) of the target image 13 displayed on the screen 11 is successively input into an enlargement and reduction controller 22. The reference image 14 is enlarged and reduced on the screen 11 in connection with the magnification of the target image 13 by a reference object display processor 21.

In the above construction shown in FIGS. 1 and 2, the user can instinctively and visually understand to which extent the target image 13 is enlarged and/or reduced by simultaneously displaying a reference image 14 of a reference object such as a pack of cigarettes or other object readily understood by those skilled in the art.

Accordingly, it is possible for the user to always easily understand the enlargement rate and/or a reduction rate, to prevent “overdesign” of the image dimensions to obtain unnecessary accuracy that is not required for in a given design, thereby enhancing efficiency in design, and abbreviating lead-time of object design.

As discussed above, the known reference object is an object for which the actual size is easily and instinctively understood, such as a pack of cigarettes, a coin of a predetermined denomination, a business card, a postcard, a postage stamp, a floppy disk, a CD, a computer keyboard, a human hand, a cassette tape, and the like.

If an image of an target object (for example, a jig or the like) and the reference object are simultaneously displayed together on the screen, actual size of the target object can be easily determined by the user.

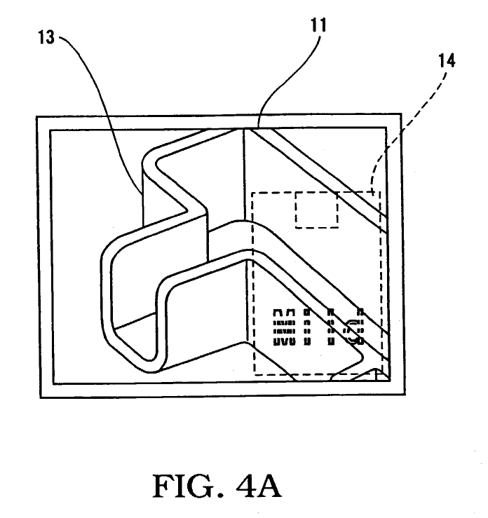

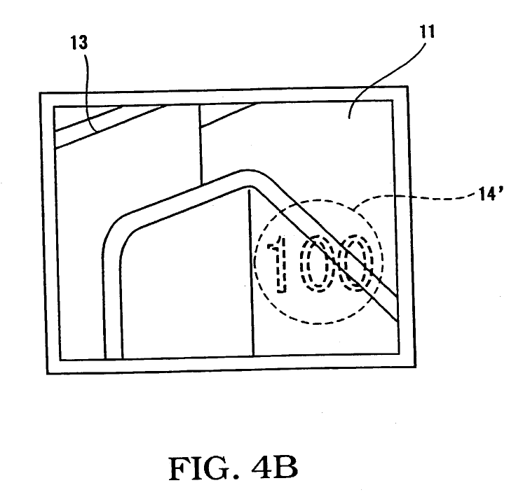

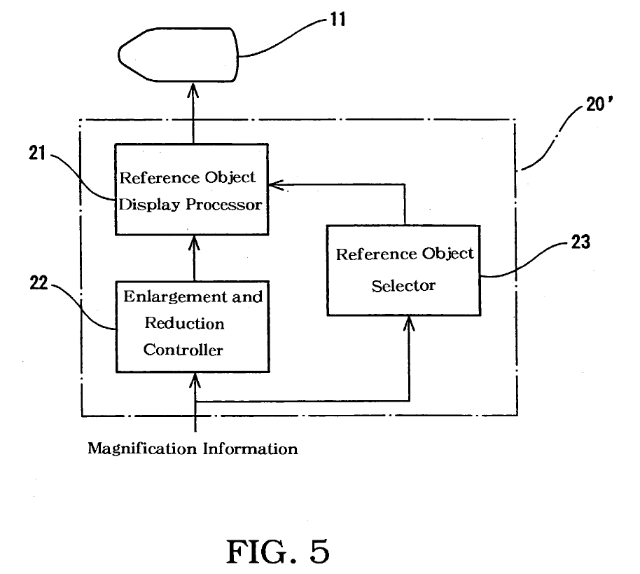

FIGS. 4A, 4B and 5 show a second embodiment of the image display apparatus in accordance with the present invention.

The second embodiment is different from the first embodiment in that a type of reference object is automatically changed on the screen 11 in accordance with the enlargement rate and/or reduction rate. FIG. 4A shows a reference image 14 of a pack of cigarettes before enlargement of the target image 13.

In the second embodiment, when the reference image 14 of the pack of cigarettes cannot entirely fit on the screen 11, the reference image 14 is automatically changed to a new, smaller reference image 14′ of a coin, which is smaller than the pack of cigarettes, shown in FIG. 4B. Consequently, even if the target image 13 is heavily enlarged, the new reference image 14′ can be fitted on the screen 11. If the reference image 14 is continuously enlarged in to the point where it cannot entirely fit on the screen 11, it may otherwise be difficult for the user to understand the enlargement rate or the reduction rate of the target image 13.

In the case of extreme reduction of the target image 13, the same principle is applied. A reference object having a most suitable size is selected in accordance with a size of the target image 13.

For example, in the present invention, if the target image 13 is a passenger jetliner, the reference image 14 selected to be displayed on the screen 11 may be a telephone booth; however, if a portion of the jetliner target image displayed on the screen is enlarged to show only a passenger window, the entire image of the telephone booth reference image 14 does not fit on the screen, so the present invention provides a replacement reference image 14′ in the form of, for example, a telephone touch-tone keypad. This feature is also provided when enlarging the image as well.

As shown in a flowchart illustrated in FIG. 5, system 20′ for enlarging and reducing the reference images 14 and 14′ successively apply magnification information (enlargement rate and reduction rate) of the target image 13 displayed on the screen 11 to an enlargement and reduction controller 22 and a reference object selector 23 in the second embodiment. A reference image 14′ of a reference object having a most suitable real size is selected on the basis of magnification information inputted in the reference object selector 23. The selected reference image 14′ is enlarged and/or reduced on the screen 11 in connection with the magnification of the target image 13 by a reference object display processor 21.

According to the present invention, since the reference object having a size suitable for a displayed size of the target image 13 is automatically selected, the user can instinctively and easily understand the present enlargement and/or reduction rate of the target image 13 throughout an enlargement or reduction range.

As with the first embodiment, if a user or group of users are familiar with a particular reference object, the reference object may be customized by optionally selecting and adding a specific kind of reference object, thus explanation of this feature is omitted herein.

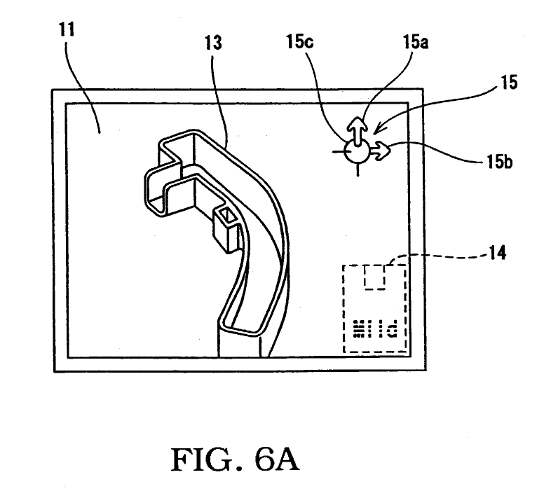

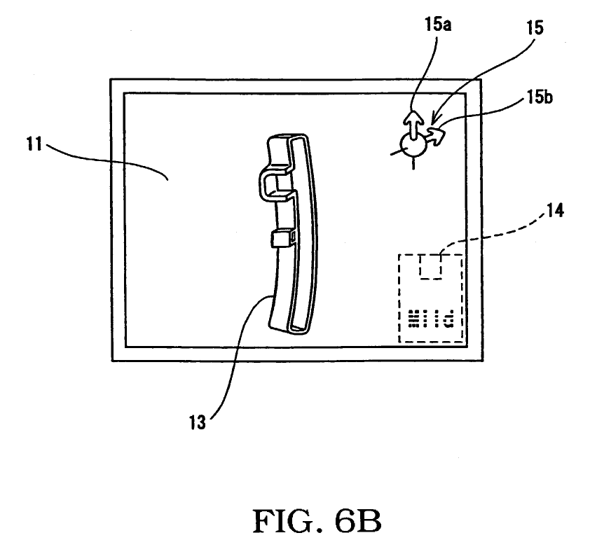

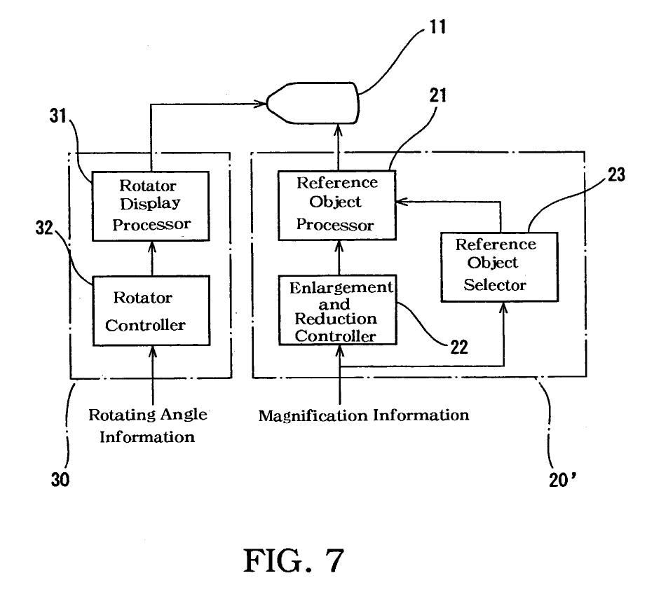

FIGS. 6A, 6B and 7 show a third embodiment of the image display apparatus in accordance with the present invention. The third embodiment is different from the second embodiment in that, in addition to displaying the reference image 14, a rotation indicator 15 is displayed on the screen 11 in order to indicate a rotating angle of the target image 13.

When the target image 13 of the target object is three-dimensionally displayed on the screen 11 during designing, the user rotates the target image 13 at various rotating angles on the screen by using an input device such as a mouse, digitizer, or the like.

In the third embodiment, the rotation indicator 15 is displayed on the screen 11 together with the reference image 14, the target image 13 is also being displayed on the screen. The rotation indicator 15 includes a sphere-like central section 15c that is a center of rotation, an upward indicating section 15a that is an arrow indicating an upward direction, and a right side indicating section 15b that is an arrow indicating a right side direction.

Indicating words such as “UP” and “R” (not shown) may be marked near the upward indicating section 15a and the right side indicating section 15b, respectively, to distinguish them from each other. Color-coded, hatched, marked or other distinctions may also be present in the sections 15a, 15b to distinguish them from each other.

When the user rotates the target image 13 by using the input device, the rotation indicator 15 rotates in the same direction in connection with rotation of the target image 13. For example, as shown in FIG. 6B, when the target image 13 is rotated to the right direction, the rotation indicator 15 correspondingly and automatically rotates to the right direction.

In the third embodiment, a rotating system 30 for rotating the rotation indicator 15 is provided, in addition to providing the enlarging and reducing system 20′, described above. As shown in a flowchart illustrated in FIG. 7, rotating angle information of the target image 13 displayed on the screen 11 is successively input into a rotation indicator controller 32. The rotation indicator 15 is rotated on the screen 11 in connection with rotation of the target image 13 by a rotation indicator display processor 31.

The user can move the rotation indicator IS displayed on the screen 11 to any desired position on the screen by “dragging” the rotation indicator 15 by using the mouse or the like, as readily understood by those skilled in the art. Further, in all described embodiments, the reference image 14 may similarly be “dragged” to any desired position on the screen.

The aforementioned configuration of the rotation indicator is not limited to the above configuration. It is readily understood by those skilled in the art that the configuration of the rotation indicator may be of any configuration that can satisfactorily indicate a direction of rotation of an image.

It is noted that the foregoing examples have been provided merely for the purpose of explanation and are in no way to be construed as limiting of the present invention. While the present invention has been described with reference to certain embodiments, it is understood that the words which have been used herein are words of description and illustration, rather than words of limitation. Changes may be made, within the purview of the appended claims, as presently stated and as amended, without departing from the scope and spirit of the present invention in its aspects. Although the present invention has been described herein with reference to particular means, materials and embodiments, the present invention is not intended to be limited to the particulars disclosed herein; rather, the present invention extends to all functionally equivalent structures, methods and uses, such as are within the scope of the appended claims.

The present application claims priority under 35 U.S.C. § 119 of Japanese Patent Application No. 2002-040065, filed on Feb. 18, 2002, the disclosure of which is expressly incorporated by reference herein in its entirety.

What is claimed is:

1. An image display apparatus in which an actual size of a target object can be determined by a user, the display apparatus comprising:
a target image of a target object configured to be displayed on a computer screen; and
a reference image of a reference object configured to be displayed on the computer screen together with said target image, a size of the reference object known to the user, wherein the user may visually recognize the actual size of the target object on the computer screen by comparing said target image with said reference image.

2. The image display apparatus according to claim 1, wherein:
said target image of the target object is configured to be at least one of enlarged and reduced on the computer screen; and
said reference image of said reference object is configured to correspondingly be at least one of enlarged and reduced on the computer screen in accordance with a respective at least one of an enlargement rate and a reduction rate of said target image.

3. The image display apparatus according to claim 1, wherein said reference image of the reference object is configured to at least one of be displayed on a blank area of the computer screen, and translucently overlap said target image.

4. The image display apparatus according to claim 2, wherein said reference image of the reference object is configured to at least one of be displayed on a blank area of the computer screen, and translucently overlap said target image.

5. The image display apparatus according to claim 1, wherein said reference object is one of a pack of cigarettes, a coin of a predetermined denomination, a business card, a postcard, a postage stamp, a floppy disk, a CD, a computer keyboard, a human hand, a telephone booth, a telephone keypad, and a cassette tape.

6. The image display apparatus according to claim 2, wherein said reference object is one of a pack of cigarettes, a coin of a predetermined denomination, a business card, a postcard, a postage stamp, a floppy disk, a CD, a computer keyboard, a human hand, a telephone booth, a telephone keypad, and a cassette tape.

7. The image display apparatus according to claim 3, wherein said reference object is one of a pack of cigarettes, a coin of a predetermined denomination, a business card, a postcard, a postage stamp, a floppy disk, a CD, a computer keyboard, a human hand, a telephone booth, a telephone keypad, and a cassette tape.

8. The image display apparatus according to claim 4, wherein said reference object is one of a pack of cigarettes, a coin of a predetermined denomination, a business card, a postcard, a postage stamp, a floppy disk, a CD, a computer keyboard, a human hand, a telephone booth, a telephone keypad, and a cassette tape.

9. The image display apparatus according to claim 1, further comprising a rotation indicator configured be displayed on the screen and further configured to indicate a direction in association with an orientation of said target image, said rotation indicator configured to rotate in association with rotation of said target image, wherein:
wherein the image display apparatus is a CAD (computer aided design) apparatus; and said target image has a three-dimensional appearance on the screen.

10. The image display apparatus according to claim 2, further comprising a rotation indicator configured be displayed on the screen and further configured to indicate a direction in association with an orientation of said target image, said rotation indicator configured to rotate in association with rotation of said target image, wherein:
wherein the image display apparatus is a CAD (computer aided design) apparatus; and said target image has a three-dimensional appearance on the screen.

11. The image display apparatus according to claim 3, further comprising a rotation indicator configured be displayed on the screen and further configured to indicate a direction in association with an orientation of said target image, said rotation indicator configured to rotate in association with rotation of said target image, wherein:
wherein the image display apparatus is a CAD (computer aided design) apparatus; and said target image has a three-dimensional appearance on the screen.

12. The image display apparatus according to claim 4, further comprising a rotation indicator configured be displayed on the screen and further configured to indicate a direction in association with an orientation of said target image, said rotation indicator configured to rotate in association with rotation of said target image, wherein:
wherein the image display apparatus is a CAD (computer aided design) apparatus; and said target image has a three-dimensional appearance on the screen.

13. The image display apparatus according to claim 5, further comprising a rotation indicator configured be displayed on the screen and further configured to indicate a direction in association with an orientation of said target image, said rotation indicator configured to rotate in association with rotation of said target image, wherein:
wherein the image display apparatus is a CAD (computer aided design) apparatus; and said target image has a three-dimensional appearance on the screen.

14. The image display apparatus according to claim 6, further comprising a rotation indicator configured be displayed on the screen and further configured to indicate a direction in association with an orientation of said target image, said rotation indicator configured to rotate in association with rotation of said target image, wherein:
wherein the image display apparatus is a CAD (computer aided design) apparatus; and said target image has a three-dimensional appearance on the screen.

15. The image display apparatus according to claim 7, further comprising a rotation indicator configured be displayed on the screen and further configured to indicate a direction in association with an orientation of said target image, said rotation indicator configured to rotate in association with rotation of said target image, wherein:
wherein the image display apparatus is a CAD (computer aided design) apparatus; and said target image has a three-dimensional appearance on the screen.

16. The image display apparatus according to claim 8, further comprising a rotation indicator configured be displayed on the screen and further configured to indicate a direction in association with an orientation of said target image, said rotation indicator configured to rotate in association with rotation of said target image, wherein:
wherein the image display apparatus is a CAD (computer aided design) apparatus; and said target image has a three-dimensional appearance on the screen.

17. The image display apparatus according to claim 1, further comprising an additional reference image configured to replace said reference image when said target image is one of enlarged and reduced, an actual size of said additional reference image being smaller than said reference image when said target image is enlarged on the screen, and the actual size of the additional reference image being larger than said reference image when said target image is reduced on the screen.

18. The image display apparatus according to claim 17, wherein the entirety of at least one of said reference image and said additional reference image is configured to fit the screen.

19. An image display method comprising:
displaying a target image of a target object on a computer screen;
displaying, together with the target image, a reference image of a reference object on the computer screen, a size of the reference object known to a user;
comparing the target image with the reference image; and
visually recognizing, by the user, the actual size of the target object on the computer screen.

20. The image display method according to claim 19, further comprising:
at least one of enlarging and reducing the target image on the computer screen; and
correspondingly enlarging the reference image on the computer screen when the target image is enlarged, and correspondingly reducing the reference image on the computer screen when the target image is reduced.

21. The image display method according to claim 19, further comprising at least one of:
displaying the reference image on a blank area of the computer screen; and
translucently overlapping the reference image over the target image.

22. The image display method according to claim 19, wherein the reference object is one of a pack of cigarettes, a coin of a predetermined denomination, a business card, a postcard, a postage stamp, a floppy disk, a CD, a computer keyboard, a human hand, a telephone booth, a telephone keypad, and a cassette tape.

23. The image display method according to claim 19, further comprising:
displaying a rotation indicator on the screen;
indicating, with the rotation indicator, a direction in association with an orientation of the target image; and
rotating the rotation indicator in association with rotation of the target image, wherein the target image has a three-dimensional appearance on the screen.

24. The image display method according to claim 19, further comprising replacing the reference image with an additional reference image when the target image is one of enlarged and reduced, an actual size of the additional reference image being smaller than the reference image when the target image is enlarged on the screen, and the actual size of the additional reference image being larger than the reference image when the target image is reduced on the screen.

25. The image display method according to claim 24, wherein the entirety of at least one of the reference image and the additional reference image fits the screen.
